(19) United States
(12) Patent Application Publication
(10) Pub. No.: US 2008/0169265 A1
(43) Pub. Date: Jul. 17, 2008

(54) Bottle allowing connection in series

(75) Inventors: Tzu Chiao Huang, Dajia Township (TW); Chia Wei Chang, Jhonghe City (TW)

Correspondence Address: RABIN & Berdo, PC, 1101 14TH STREET, NW, SUITE 500, WASHINGTON, DC, 20005, US

(73) Assignee: MOD DESIGN DEVELOPMENT LTD.

(21) Appl. No.: 11/652,663

(22) Filed: Jan. 12, 2007

(51) Int. Cl. B29C 49/00

(52) U.S. Cl. 215/370

(57) ABSTRACT

A bottle allowing connection in series includes a bottle body having a mouth, a receiving section connected to and extended into an open bottom of the bottle body, and a passively movable opening device mounted in an upper portion of the receiving section and forward movable by a force applied thereto. A first bottle body may be serially connected at the mouth to the receiving section at the bottom of a second bottle body. When the first bottle body is turned relative to the second bottle body, the opening device in the receiving section of the second bottle body is moved forward to open a sealed top of the receiving section, allowing liquid contents in the two bottle bodies to be conveniently mixed without the need of a third container.

### FIELD OF THE INVENTION

The present invention relates to a bottle allowing connection in series, and more particularly to a bottle having correspondingly designed mouth and bottom, such that a first bottle may be serially connected at the mouth to the bottom of a second bottle to cut open the bottom of the second bottle, allowing liquid contents in the two bottles to be evenly mixed without using a third container.

### BACKGROUND OF THE INVENTION

Most of the commercially available beverages contain either one single flavor or multiple mixed flavors. However, it is a pity that not all the commercially prepared beverages would satisfy all consumers' preferences. Some of the consumers select to buy differently flavored beverages and mix them depending on personal preference. Sometimes, the consumer-mixed beverages indeed have unique and pleasant flavors.

The generally available bottles for beverages have a structure that does not allow serial connection of one bottle to another one, in order to mix the beverages contained in the two bottles. When it is desired to mix two bottles of beverages, a third bottle or container must be prepared for accommodating and mixing the beverages from the two bottles. It is no doubt very troublesome for consumers to do so, and a bottle having a structure allowing serial connection of it to another one for directly mixing the beverages is therefore desirable.

### SUMMARY OF THE INVENTION

A primary object of the present invention is to provide a bottle allowing connection in series, such that a first bottle may be serially connected at a mouth to a bottom of a second bottle, allowing the two bottles to communicate with each other to mix beverages therein and create a unique new taste.

Another object of the present invention is to provide a bottle allowing connection in series, such that a user may conveniently serially connect two bottles together to evenly mix the beverages therein without the need of a third bottle or container.

To achieve the above and other objects, the bottle allowing connection in series according to the present invention includes a bottle body having a mouth and an open bottom, a receiving section connected to and extended into the open bottom of the bottle body for receiving a mouth of another bottle body, and a passively movable opening device. The receiving section is communicable with an inner space of the bottle body and provided on an inner surface with an internally threaded section, and the passively movable opening device is mounted in an upper portion of the receiving section and forward movable by a force applied thereto.

The mouth of the bottle body is provided around an outer surface with a first sealing element. The first sealing element may be otherwise integrally formed around the mouth. In a feasible embodiment, the sealing element is a seal ring. The mouth may be closed with a cap. The mouth is also formed on the outer surface with a first externally threaded section, and in an upper rim with a first engaging section.

In a first embodiment of the present invention, the opening device is a cutting element mounted in the receiving section. The cutting element is provided along an upper rim with at least one toothed section, and along a lower rim with a second engaging section meshing with the first engaging section in the mouth. Moreover, the cutting element is provided on an outer surface with a second externally threaded section meshing with the internally threaded section of the receiving section.

In the first embodiment, the receiving section is provided at a top opening with an inner sealing layer.

In a second embodiment of the present invention, the passively movable opening device includes a ball seat fitted around an upper portion of the receiving section, and a sealing ball tightly held to an inner side of the ball seat.

In either embodiment, the receiving section is provided in a lower opening with a second sealing element, which may be otherwise integrally formed in the lower opening of the receiving section. In the feasible embodiment of the present invention, the second sealing element is a seal ring.

The receiving section is also provided at the lower opening with an outer sealing layer. Both the inner and the outer sealing layer are made of aluminum foil to prevent liquid content in the bottle body from leaking out via the receiving section and protect the liquid content in the bottle body against external dust and contaminants.

With the bottle structure provided by the present invention, a first bottle may be serially connected at the mouth to the receiving section at the bottom of a second bottle while the passively movable opening device opens the sealed top opening of the receiving section of the second bottle, allowing liquid contents in the two bottles to be evenly mixed to create a personally preferred unique flavor without using a third container.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a bottle allowing connection in series according to a first embodiment of the present invention;

FIG. 2 is a partially exploded perspective view of the bottle of FIG. 1;

FIG. 3 is a fully exploded perspective view of the bottle of FIG. 1;

FIG. 4 is a perspective view showing two bottles of FIG. 1 are to be serially connected to each other;

FIG. 5 is a perspective view showing the two bottles of FIG. 4 have been serially connected to each other;

FIG. 6 is a sectioned side view showing two bottles of FIG. 1 are to be serially connected to each other;

FIG. 7 is a sectioned side view showing the two bottles of FIG. 6 have been serially connected to each other;

FIG. 8 is a sectioned side view showing the manner of cutting open an inner sealing layer in the bottom of a preceding bottle of FIG. 7;

FIG. 9 is an assembled perspective view of a bottle allowing connection in series according to a second embodiment of the present invention;

FIG. 10 is a fully exploded perspective view of the bottle of FIG. 9;

FIG. 11 is a sectioned side view showing two bottles of FIG. 9 are to be serially connected to each other;

FIG. 12 is a sectioned side view showing the two bottles of FIG. 11 have been serially connected to each other; and

FIG. 13 is a sectioned side view showing the manner of pushing away a sealing ball in the bottom of a preceding bottle in FIG. 12.

### DETAILED DESCRIPTION OF THE PREFERRED EMBODIMENTS

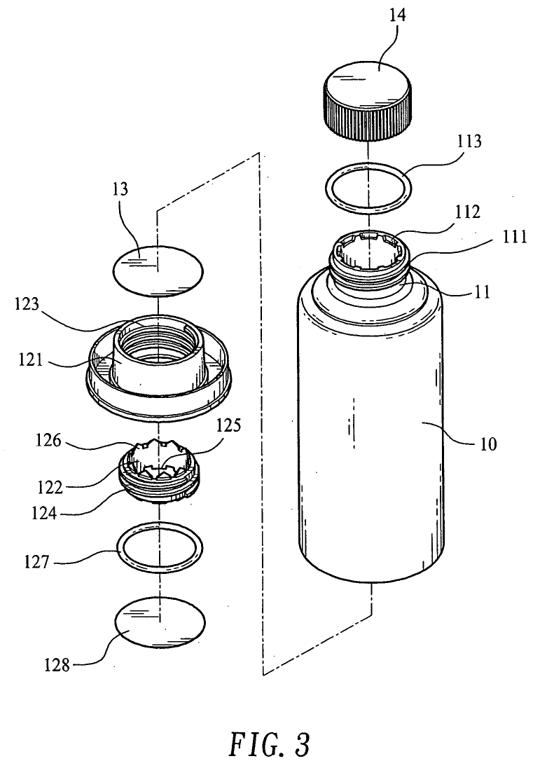

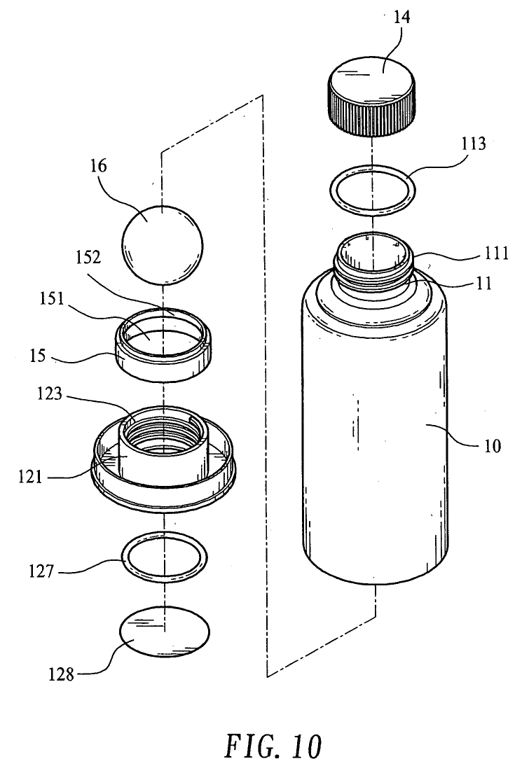

Please refer to FIGS. 3 and 10 that are fully exploded perspective views of two bottles allowing connection in series according to a first and a second embodiment, respectively, of the present invention. Both of the first and the second embodiment of the present invention include a bottle body 10, having a mouth 11, and a receiving section 121 connected to and extended into a bottom of the bottle body 10 for receiving and engaging with a mouth 11 of another bottle body 10. The receiving section 121 is communicable with an inner space of the bottle body 10, and is provided at an inner surface with an internally threaded section 123. A passively movable opening device is assembled to the receiving section 121.

A first sealing element 113 is externally provided or integrally formed around the mouth 11. In the illustrated embodiments, the first sealing element 113 is a seal ring. The mouth 11 is closed with a cap 14, and includes a first externally threaded section 111.

In the first embodiment, the mouth 11 is provided along an inner rim with a first engaging section 112. The opening device includes a cutting element 122, which is provided with a second externally threaded section 124 meshing with the internally threaded section 123 of the receiving section 121, so that the cutting element 122 may be screwed into the receiving section 121. The cutting element 122 is provided along a lower rim with a second engaging section 125 meshing with the first engaging section 112 in the mouth 11, and along an upper rim with at least one toothed section 126. An inner sealing layer 13 is provided to openably seal a top opening of the receiving section 121.

In the second embodiment, the opening device includes a ball seat 15 fitted around an upper portion of the receiving section 121, and a sealing ball 16 held in a bore 151 of the ball seat 15.

In both of the first and the second embodiment, a second sealing element 127 is mounted in a lower opening of the receiving section 121. Alternatively, the second sealing element 127 may be integrally formed in the lower opening of the receiving section 121. In the illustrated embodiments, the second sealing element 127 is a seal ring.

In both of the first and the second embodiment, the lower opening of the receiving section 121 is openably sealed by an outer sealing layer 128 to prevent liquid content in the bottle body 10 from leaking out via the receiving section 121, and protect the liquid content against external dust and contaminants.

In the illustrated embodiments, the inner and outer sealing layers 13, 128 are made of aluminum foil.

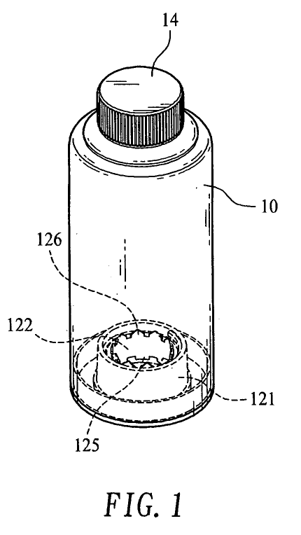

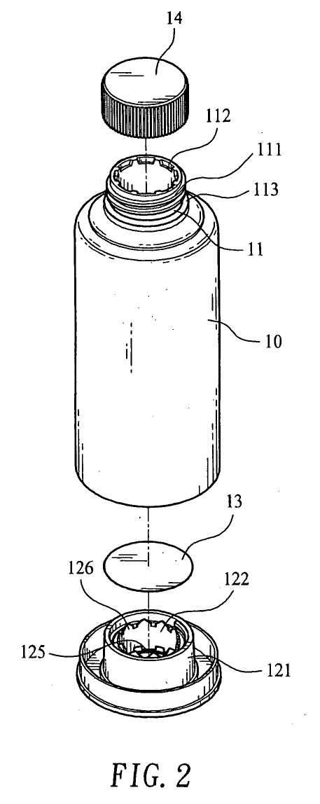

Please refer to FIGS. 1 to 3, in which the bottle allowing connection in series according to the first embodiment of the present invention is shown. As shown, the bottle includes a bottle body 10 having a mouth 11; a receiving section 121 connected to and extended into a bottom of the bottle body 10 for receiving and engaging with a mouth 11 of another bottle body 10, the receiving section 121 being communicable with an inner space of the bottle body 10, and being provided at an inner surface with an internally threaded section 123, and at a top opening with an openably sealed inner sealing layer 13; and a cutting element 122 assembled to an inner side of the receiving section 121 for cutting open the inner sealing layer 13. A first sealing element 113 is externally provided or integrally formed around the mouth 11. The mouth 11 is closed with a cap 14, and is provided on an outer surface with a first externally threaded section 111 and along an inner rim with a first engaging section 112.

The cutting element 122 is provided with a second externally threaded section 124 for meshing with the internally threaded section 123 of the receiving section 121, and can therefore be screwed into the receiving section 121. The cutting element 122 is provided along a lower rim with a second engaging section 125 meshing with the first engaging section 112 in the mouth 11, and along an upper rim with at least one toothed section 126.

A second sealing element 127 is mounted in a lower opening of the receiving section 121. Alternatively, the second sealing element 127 may be integrally formed in the lower opening of the receiving section 121. In a preferred embodiment, the second sealing element 127 is a seal ring. The lower opening of the receiving section 121 is openably sealed by an outer sealing layer 128 to prevent liquid content in the bottle body 10 from leaking out via the receiving section 121, and protect the liquid content against external dust and contaminants.

Both of the inner sealing layer 13 and the outer sealing layer 128 are made of aluminum foil.

To form the complete bottle according to the first embodiment of the present invention, first screw the cutting element 122 into the receiving section 121 by engaging the second externally threaded section 124 with the internally threaded section 123; seal the top opening of the receiving section 121 with the inner sealing layer 13; mount the second sealing element 127 in the lower opening of the receiving section 121 below the internally threaded section 123; seal the lower opening of the receiving section 121 with the outer sealing layer 128; and mount the receiving section having the opening device mounted therein to an open bottom of the bottle body 10 to seal the bottle bottom.

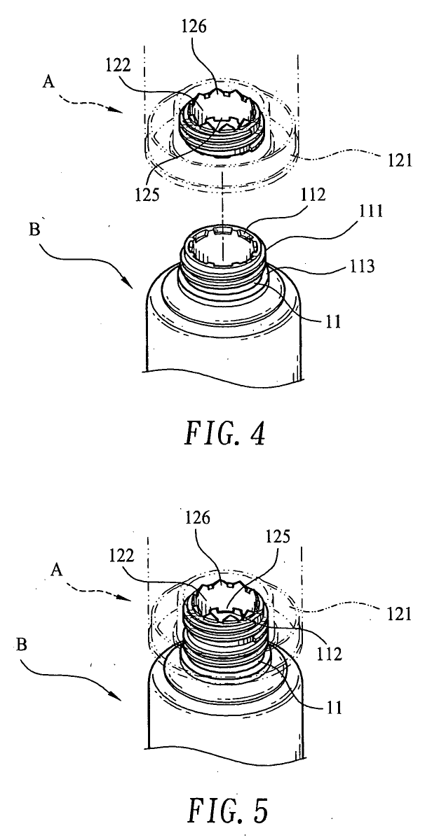

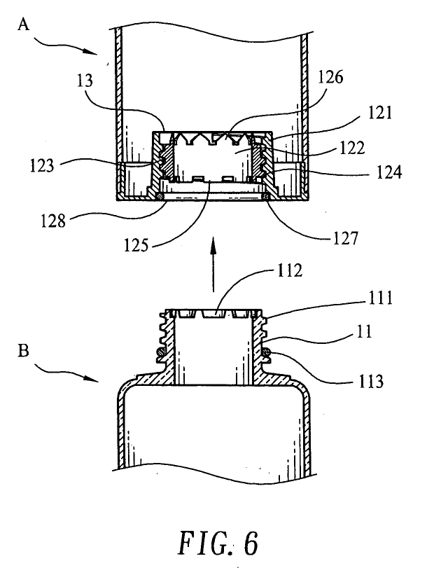

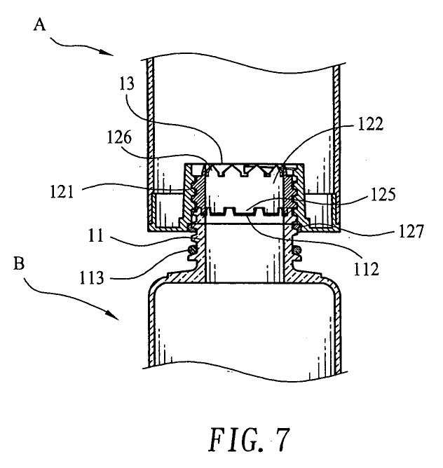

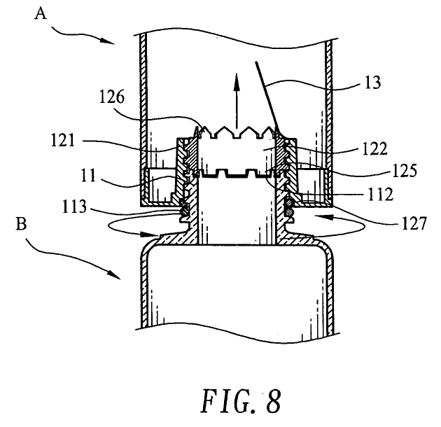

Please refer to FIGS. 4 through 8 that show the serial connection of two bottles A and B according to the first embodiment of the present invention. In the illustrated drawings, the bottle A is located at an upper position, while the bottle B is located below the bottle A. To connect the bottle A to the bottle B, first remove the outer sealing layer 128 at the bottom of the bottle A; align the bottle B with the bottle A; screw, the mouth 11 of the bottle B into the lower opening of the receiving section 121 of the bottle A by engaging the first externally threaded section 111 of the bottle B with the internally threaded section 123 of the bottle A; turn the bottle B counterclockwise to spirally move it upward, so that the first engaging section 112 in the mouth 11 of the bottle B is engaged with the second engaging section 125 at the lower rim of the cutting element 122 of the bottle A; and keep turning the bottle B for the cutting element 122 of the bottle A to spirally move upward until the inner sealing layer 13 is cut open by the toothed section 126 around the upper rim of the cutting element 122. When the bottle B is turned to an upper dead point in the receiving section 121 of the bottle A, the bottle B could not be turned any further. At this point, the inner sealing layer 13 of the bottle A is cut open with only a small part thereof connected to the top opening of the receiving section 121 without the risk of separating therefrom, as shown in FIG. 8, and the liquid content in the bottle A is allowed to flow into and mix with the liquid content in the bottle B. A user may shake the serially connected bottles A and B to evenly mix the liquid contents thereof.

With the bottle of present invention, a user may discretionarily choose and combine two different beverages. For instance, the user may choose to mix milk with tea, such as red tea, green tea, or other kinds of tea, of different degrees of sweetness, such as sugar-free, low sugar, or high-sugar level, using two bottles of the present invention serially connected together in the above described manner. A new beverage with a unique taste can be then produced.

The bottles of the present invention may also be used to combine different liquids other than beverages or drinks, so as to be utilized in other industrial fields.

With the bottle of the present invention, two different liquids may be directly mixed with each other without the necessity of preparing a third bottle or container. And, the bottle of the present invention allows consumers to enjoy the pleasure and fun of mixing different drinks completely at their own discretion, and to enjoy drinks of completely new taste.

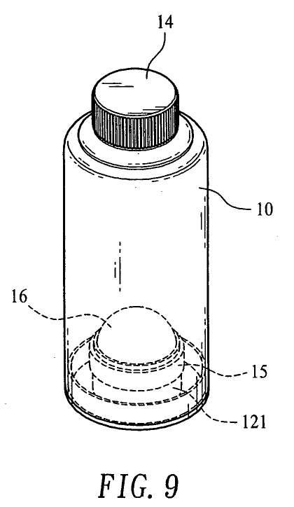

FIGS. 9 and 10 are assembled and exploded perspective views, respectively, of a bottle allowing connection in series according to a second embodiment of the present invention. The bottle in the second embodiment also includes a bottle body 10 having a mouth 11, a receiving section 121 connected to and extended into a bottom of the bottle body 10 for receiving and engaging with a mouth 11 of another bottle body 10. The receiving section 121 is communicable with an inner space of the bottle body 10, and is provided at an inner surface with an internally threaded section 123. A first sealing element 113 is externally provided or integrally formed around the mouth 11. In the illustrated second embodiment, the first sealing element 113 is a seal ring. The mouth 11 is closed with a cap 14, and includes a first externally threaded section 111. A second sealing element 127 is mounted in a lower opening of the receiving section 121. Alternatively, the second sealing element 127 may be integrally formed in the lower opening of the receiving section 121. In the illustrated second embodiment, the second sealing element 127 is a seal ring. The lower opening of the receiving section 121 is openably sealed by an outer sealing layer 128 to prevent liquid content in the bottle body 10 from leaking out via the receiving section 121, and protect the liquid content against external dust and contaminants.

The bottle in the second embodiment includes a passively movable opening device consisting of a ball seat 15 fitted around an upper portion of the receiving section 121, and a sealing ball 16 held in the ball seat 15. The ball seat 15 is slightly larger than the receiving section 121, and defines a central hollow bore 151 for firmly holding the sealing ball 16 therein. The bore 151 has a diametrically reduced upper portion 152 slightly smaller than an outer diameter of the sealing ball 16.

To form the complete bottle according to the second embodiment of the present invention, first put the ball seat 15 around the upper portion of the receiving section 121; tightly fit the sealing ball 16 in the bore 151 of the ball seat 15, so that the sealing ball 16 is firmly held in the bore 151 by the diametrically reduced upper portion 152 of the bore 151; mount the second sealing element 127 in the lower opening of the receiving section 121 below the internally threaded section 123; and seal the lower opening of the receiving section 121 with the outer sealing layer 128; and mount the receiving section with the ball seat 15 and the sealing ball 16 held thereto to an open bottom of the bottle body 10 to seal the bottle bottom.

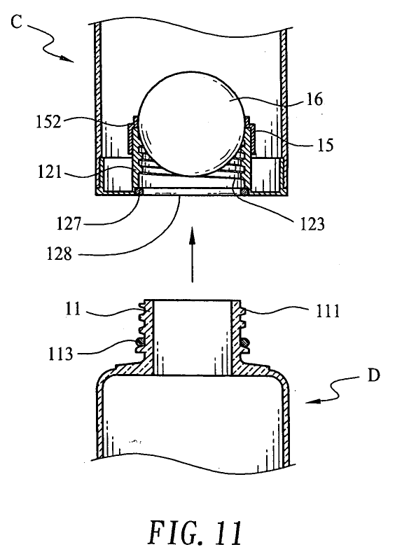

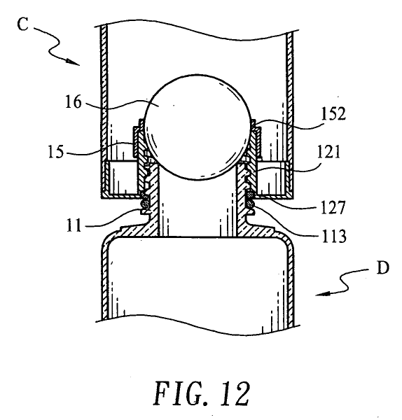

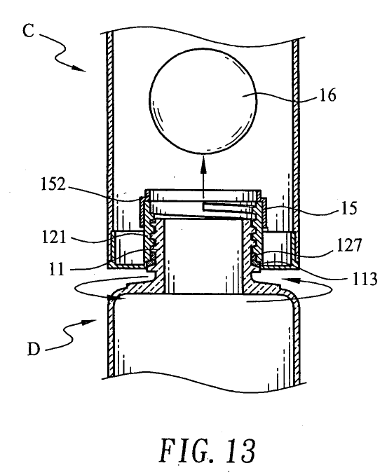

Please refer to FIGS. 11 through 13 that show the serial connection of two bottles C and D according to the second embodiment of the present invention. In the illustrated drawings, the bottle C is located at an upper position, while the bottle D is located below the bottle C. To connect the bottle C to the bottle D, first remove the outer sealing layer 128 at the bottom of the bottle C; align the bottle D with the bottle C; screw the mouth 11 of the bottle D into the lower opening of the receiving section 121 of the bottle C by engaging the first externally threaded section 111 of the bottle D with the internally threaded section 123 of the bottle C; turn the bottle D counterclockwise to spirally move it upward until the bottle D reaches at an upper dead point in the receiving section 121 of the bottle C and could not be turned any further. At this point, the sealing ball 16 of the bottle C is pushed out of the ball seat 15 by the mouth 11 of the bottle D, as shown in FIG. 13, and the liquid content in the bottle C is allowed to flow into and mix with the liquid content in the bottle D. A user may shake the serially connected bottles C and D, and the sealing ball 16 acts to more evenly mix the liquid contents of the two bottles C and D.

The receiving section 121 for the bottle of the second embodiment of the present invention also allows a mouth of a conventional bottle to screw thereinto to achieve the same purpose of pushing the sealing ball 16 out of the ball seat 15 and mixing liquid contents of two bottles.

In the present invention, since the passively movable opening device is first assembled to the receiving section 121 before the latter is mounted to the bottom of the bottle body 10, the bottle of the present invention could be more easily produced with simplified process. Alternatively, the receiving section 121 may be integrally formed at the bottom of the bottle body 10, and the passively movable opening device may be subsequently assembled to the receiving section 121.

In brief, the present invention provides a bottle body 10 being provided at an open bottom with a receiving section 121 to enable serial connection of the bottle body 10 at the receiving section 121 to a mouth 11 of another bottle body 10, so that different beverages contained in two bottle bodies 10 may be easily mixed according to a consumer's preference to create new and unique flavor.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A bottle allowing connection in series, comprising a bottle body having a mouth and an open bottom, a receiving section connected to and extended into said open bottom of said bottle body for receiving a mouth of another said bottle body, and a passively movable opening device; said receiving section being communicable with an inner space of said bottle body and provided on an inner surface with an internally threaded section, and said passively movable opening device being mounted in an upper portion of said receiving section and forward movable by a force applied thereto.

2. The bottle allowing connection in series as claimed in claim 1, wherein said mouth is provided on an outer surface with a first externally threaded section.

3. The bottle allowing connection in series as claimed in claim 1, wherein said mouth is closed with a cap.

4. The bottle allowing connection in series as claimed in claim 1, wherein said mouth is provided around a lower end thereof with a first sealing element.

5. The bottle allowing connection in series as claimed in claim 1, wherein said passively movable opening device is a cutting element mounted in said receiving section.

6. The bottle allowing connection in series as claimed in claim 5, wherein said cutting element is provided along an upper rim with at least one toothed section, and along a lower rim with a second engaging section.

7. The bottle allowing connection in series as claimed in claim 5, wherein said cutting element is provided on an outer surface with a second externally threaded section meshing with said internally threaded section of said receiving section.

8. The bottle allowing connection in series as claimed in claim 1, wherein said receiving section has a top opening openably sealed by an inner sealing layer.

9. The bottle allowing connection in series as claimed in claim 1, wherein said opening device consists of a ball seat fitted around an upper portion of said receiving section, and a sealing ball held to an inner side of said ball seat.

10. The bottle allowing connection in series as claimed in claim 1, wherein said receiving section has a lower opening, in which a second sealing element is mounted.

11. The bottle allowing connection in series as claimed in claim 1, wherein said receiving section has a lower opening, which is openably sealed by an outer sealing layer.

12. A bottle allowing connection in series, comprising a bottle body having a mouth and an open bottom, a receiving section connected to and extended into said open bottom of said bottle body for receiving a mouth of another said bottle body, and a cutting element; said receiving section being communicable with an inner space of said bottle body and provided on an inner surface with an internally threaded section, and having a top opening openably sealed by an inner sealing layer; and said cutting element being mounted in an upper portion of said receiving section for cutting open said inner sealing layer.

13. The bottle allowing connection in series as claimed in claim 12, wherein said mouth is provided on an outer surface with a first externally threaded section, and around a lower end of the outer surface with a first sealing element; and said mouth being provided along an inner rim with a first engaging section, and closed by a cap.

14. The bottle allowing connection in series as claimed in claim 12, wherein said cutting element is provided along an upper rim with at least one toothed section, and along a lower rim with a second engaging section; and wherein said cutting element is provided on an outer surface with a second externally threaded section meshing with said internally threaded section of said receiving section.

15. The bottle allowing connection in series as claimed in claim 12, wherein said receiving section has a lower opening being openably sealed by an outer sealing layer and having a second sealing element mounted therein.

16. A bottle allowing connection in series, comprising a bottle body having a mouth and an open bottom, a receiving section connected to and extended into said open bottom of said bottle body for receiving a mouth of another said bottle body, a ball seat fitted around an upper portion of said receiving section, and a sealing ball firmly held in said ball seat; said receiving section being communicable with an inner space of said bottle body and provided on an inner surface with an internally threaded section, and having an top opening openably sealed by said sealing ball.

17. The bottle allowing connection in series as claimed in claim 16, wherein said mouth is provided on an outer surface with a first externally threaded section, and around a lower end of the outer surface with a first sealing element; and wherein said mouth is closed with a cap.

18. The bottle allowing connection in series as claimed in claim 16, wherein said receiving section has a lower opening being openably sealed by an outer sealing layer and having a second sealing element mounted therein.

19. The bottle allowing connection in series as claimed in claim 16, wherein said ball seat defines a central hollow bore, said hollow bore having a diametrically reduced upper portion, and said sealing ball being held to the diametrically reduced upper portion of said hollow bore.

20. The bottle allowing connection in series as claimed in claim 19, wherein said diametrically reduced upper portion of said hollow bore of said ball seat has an inner diameter slightly smaller than an outer diameter of said sealing ball.
